(19) United States
(12) Patent Application Publication
(10) Pub. No.: US 2008/0152189 A1
(43) Pub. Date: Jun. 26, 2008

(54) Method and Apparatus For Embedding Data

(75) Inventor: Adriaan Johan Van Leest, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,022

(22) PCT Filed: Apr. 12, 2006
(86) PCT No.: PCT/IB2006/051138

§ 371 Date: Oct. 9, 2007

(30) Foreign Application Priority Data
Apr. 13, 2005 (EP) 05102922.1

(51) Int. Cl. G06K 9/00

(52) U.S. Cl. 382/100

(57) ABSTRACT

A method of embedding data such as a watermark in a two dimensional information signal such as an image. The method comprises filtering a portion of the information signal using a two dimensional filter. In order to reduce the visibility of the watermark in sharp and elongated edges, the filter is configured to apply a net weighting of approximately zero to the portion of the information signal in at least two non parallel directions. Preferably, the two directions are mutually orthogonal, e.g. horizontal and vertical. The thus filtered signal is used to locally control the watermark embedding depth (energy).

The present invention relates to a method and apparatus for embedding data in an information signal. More particularly, but not exclusively, the present invention relates to a method of embedding a watermark in an information signal.

It is now possible to easily obtain and distribute digital data using networks of computers connected together, for example, via the Internet. Such obtaining and distribution of data allows users to more readily obtain data than used to be the case. However, it also presents a problem for the owners of such data given that users can make and distribute illegitimate copies thereby reducing the legitimate income of data owners. For example, in the case of music files, it is known that some users copy files and distribute them between one another in violation of copyright laws which results in the owners of such copyright not receiving the income which is due to them. Similar problems occur with video files. In order to prevent such unauthorized copying and distribution, it is known to embed digital watermarks within information signals so as to make illegitimate copying and distribution more difficult.

The addition of a watermark to an information signal can be considered to be a distortion to that information signal. It is important that the watermark is added to the information signal in such a way that the distortion is imperceptible or near imperceptible to a user of the information signal. For example, in the case of sound data the addition of a watermark should not generate any audible difference when a user listens to that sound file. Similarly, in the case of image or video files the embedding of a watermark within the image data should not generate a perceptible distortion for a viewer of that data. It will therefore be appreciated that it is important to embed watermarks within portions of an information signal in which they will have little perceptibility to a user.

A method for partially solving this problem is described in Kalker, T. Depovere, G., Haitsma, J., and Maes, M. J.: ‘Video Watermarking System For Broadcast Monitoring’, Proc. SPIE, Volume 3657, pages 2621/2624, 1999. The method described in this paper filters an information signal using a Laplacian filter and uses the output of this filtering operation to apply a weighting to a watermark which is to be added. It is known that the Laplacian filter has a high response in textured areas and a low response in smooth areas. Given that distortions are considerably more perceptible in smooth areas than in textured areas the Laplacian filter used in that paper is effective in ensuring that distortions are at least less perceptible given that they do not affect smooth areas of the image. However, a Laplacian filter also has a high response in areas of an image which include edges. Thus, using this method distortion does occur in the region of edges. Given that it is known that distortions are relatively perceptible in such image areas, watermarks added using this method are, in some circumstances, perceptible to a user around edges within the image.

U.S. Pat. No. 6,707,930 (Kalker et al) discloses a method which seeks to overcome these problems. Specifically, instead of using a Laplacian filter four distinct filters are used:

$${L}_{h} [ \begin{matrix}- 1 & 2 & - 1 \\ - 1 & 2 & - 1 \\ - 1 & 2 & - 1\end{matrix} ] , {L}_{v} = [ \begin{matrix}- 1 & - 1 & - 1 \\ 2 & 2 & 2 \\ - 1 & - 1 & - 1\end{matrix} ] , \\ {L}_{{d}_{i}} = [ \begin{matrix}2 & - 1 & - 1 \\ - 1 & 2 & - 1 \\ - 1 & - 1 & 2\end{matrix} ] , and {L}_{{d}_{2}} [ \begin{matrix}- 1 & - 1 & 2 \\ - 1 & 2 & - 1 \\ 2 & - 1 & - 1\end{matrix} ]$$

The four filters set out above are such that their sum is equal to a Laplacian filter:

$$L = [ \begin{matrix}- 1 & - 1 & - 1 \\ - 1 & 8 & - 1 \\ - 1 & - 1 & - 1\end{matrix} ]$$

By using the four directional filters set out above, a watermark w can be separated into four directional watermarks:

w_{{h, v, d1, d2}}=L_{{h, v, d1, d2}}*(L+e)⁻¹*w

Where * denotes convolution and e is a small positive constant that prevents singularities at zeros of L. L⁻¹ is the inverse of the filter L.

Having generated four watermarks in this way their sum is approximately equal to the original watermark w:

wₕ+wᵥ+w_{d}_{₁}+w_{d}_{₂}≈w

Thus, having generated four directional filters and four directional watermarks, the watermark can be shaped as follows:

$$W ( n ) = d {\sum }_{i = \{ h , v , {d}_{1 , 2} \}} \vert ( {L}_{i} * x ) ( n ) \vert {w}_{i} ( n ) ,$$

and the shaped watermark can be added to the image data thus:

y=x+W

Although the method proposed in U.S. Pat. No. 6,707,930 is effective in overcoming the problems inherent with the use of a Laplacian filter, and ensures that perceptible distortions are not added in the regions of edges it will be appreciated that its processing is considerably more complex, requiring a plurality of filtering operations and various other manipulations as set out above.

It is an object of embodiments of the present invention to provide a method for embedding data in an information signal which obviates or mitigates at least some of the problems outlined above.

According to the present invention, there is provided, a method of embedding data in a two-dimensional information signal, the method comprising, filtering a portion of said information signal said filtering applying a net weighting of approximately zero to said portion of said information signal in at least two non-parallel directions, to generate filtered data, embedding said data in said information signal based upon said filtered data.

By using filtering which applies a net weighting of approximately zero in at least two non-parallel directions the data can be embedded in the information signal so as not to apply distortions to edges in those two non-parallel directions. For example, the two non-parallel directions could be horizontal and vertical directions within an image and the two dimensional filter could be used to ensure that no distortion is applied around those edges.

The filtering may be carried out using a two dimensional filter configured to apply a net weighting of approximately zero to said portion of said information signal in at least two non-parallel directions. Alternatively, the filtering may be carried out using a pair of filters, a first filter being configured to apply a net weighting of approximately zero to said portion of said information signal in a first direction, and a second filter being configured to apply a net weighting of approximately zero in a second direction, which is non-parallel to the first direction. Preferably, the two non-parallel directions are mutually orthogonal directions. A first example of mutually orthogonal directions are the horizontal and vertical directions. A second example of mutually orthogonal directions are two diagonal directions.

The filter may be defined by coefficients arranged in a predetermined plurality of rows and a predetermined plurality of columns, and the coefficients of each row may have a sum which is substantially equal to zero and the coefficients of each column may have a sum which is substantially equal to zero. Additionally, coefficients across one or both principal diagonals may also add up to zero.

The invention further provides a carrier medium carrying computer readable instructions, the instructions being configured to cause a computer to carry out the method set out above.

There is also provided a computer apparatus for embedding a watermark in an information signal. The apparatus comprises a program memory storing processor readable instructions and a processor configured to read and execute instructions stored in said program memory. The processor readable instructions comprise instructions controlling the processor to carry out the method set out above.

Embodiments of the present invention will now be described, by way of example, with reference to the accompanying drawings, in which:

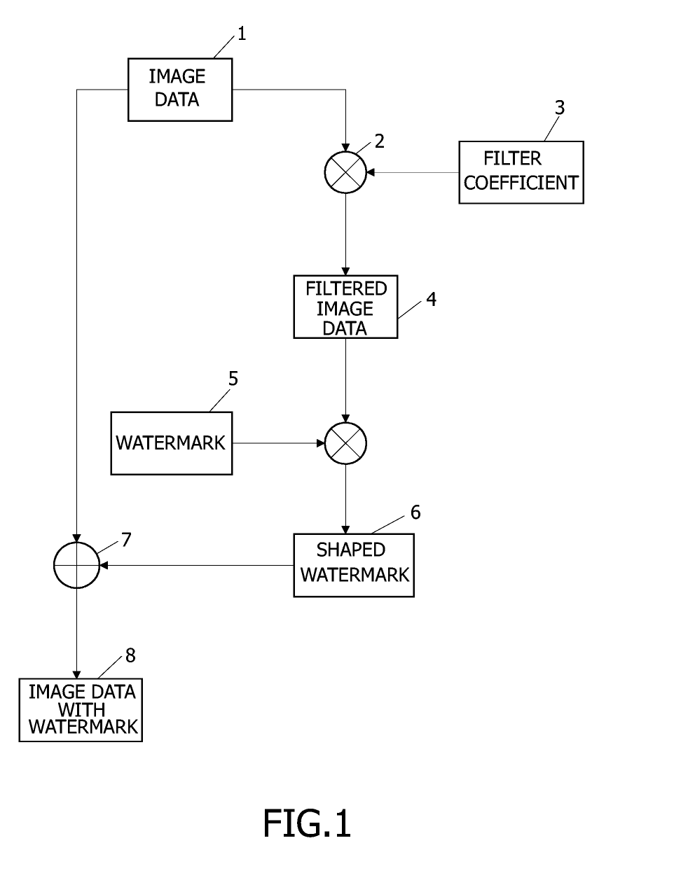

FIG. 1 is a schematic illustration of a method used in embodiments of the present invention for embedding a watermark in an image;

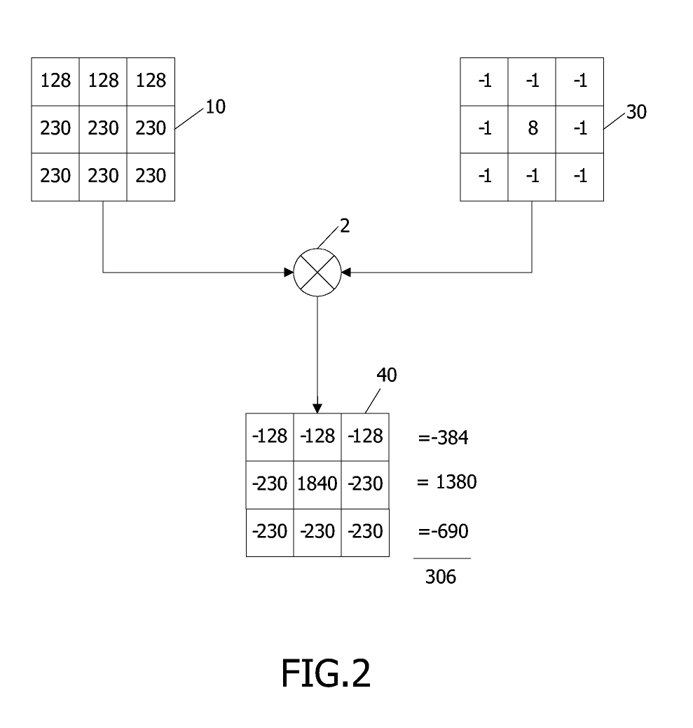

FIG. 2 is a schematic illustration of image filtering in accordance with a prior art technique; and

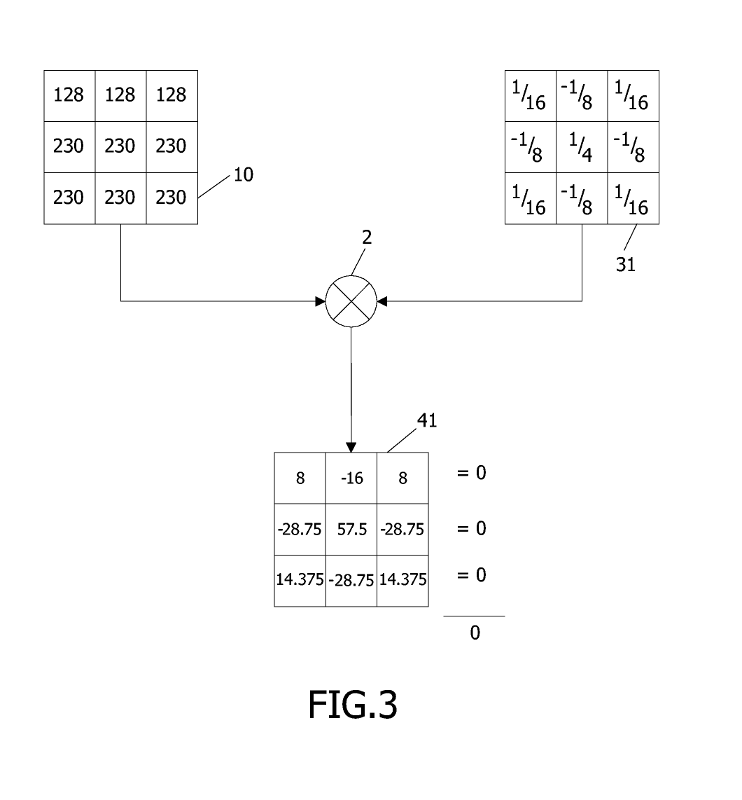

FIG. 3 is a schematic illustration of image filtering in accordance with an embodiment the present invention.

The addition of a watermark to an image can be considered to be a distortion of the image, given that some pixel values will be modified to include the watermark data. It is desirable that the watermark is added to the image in such a way that little perceptible distortion occurs to the image.

It is important to take into account the way in which different image distortions are perceived by the Human Visual System (HVS), when deciding how a watermark should be added. The HVS is such that that distortions have little visibility in textured areas, but high visibility in smooth areas and areas around edges. Areas around horizontal and vertical edges are particularly susceptible to distortion perceptibility. Additionally, distortion perceptibility varies with brightness such that distortions are more perceptible in the midrange luminance values.

Given these features of the HVS, it can be seen that the watermark should ideally be embedded within a textured area, and not within an area which is smooth or includes an edge, particularly a horizontal or vertical edge.

As is now described, in accordance with the described embodiment of the present invention, the image data is filtered using a filter configured to have a high response in areas where distortions are relatively imperceptible to the HVS. This filtered image data can then be used to shape the watermark such that it is applied in areas in which distortions are relatively imperceptible to the HVS.

Referring to FIG. 1, image data 1 is filtered by a filter 2 which uses filter coefficients 3. This generates filtered image data 4. A watermark 5 is shaped by multiplying respective values of the watermark 5 with respective values of the filtered image data 4. The watermark may also be clipped. This generates a shaped watermark 6. The shaped watermark 6 is then applied to the image data 1 by an adder 7 which adds appropriate values of the shaped watermark 6 to appropriate values of the image data 1. This generates image data 8 which includes the watermark.

Embedding of a watermark is described by equation (1):

y(n)=x(n)+d|(x*G₀)(n)|w(n) (1)

Where: x is the input image data 1;

G₀ is the set of filter coefficients 3;

w is the watermark 5;

d is a scalar depth parameter; and

y is the output image.

It can be seen that in equation (1) a value for a particular pixel n of the output image y, is generated by manipulating that same pixel n of the input image data x (after filtering), and a respective value of the watermark w. It can be seen that the equation uses the absolute value of the filtered data.

The scalar depth parameter d is a watermark energy parameter set by a user. If a high energy watermark is required (for example because of robustness requirements), then the user should choose a relatively large value for parameter d.

One known prior art method for embedding watermarks filters image data 1 (x) is illustrated in FIG. 2.

Referring to FIG. 2, a portion 10 of the image data 1 comprises a 3-by-3 array of 9 pixels having pixel values as shown in FIG. 2. It can be seen that the illustrated portion 10 represents a horizontal edge within the image, with the uppermost row of the array being on one side of the edge, and the two lowermost rows of the array being on the other side of the edge.

The filter coefficients 3 of FIG. 1 are a 3-by-3 array 30 which is a Laplacian high-pass filter L:

$$L = [ \begin{matrix}- 1 & - 1 & - 1 \\ - 1 & 8 & - 1 \\ - 1 & - 1 & - 1\end{matrix} ] \qquad ( 2 )$$

The Laplacian high-pass filter L, is known to have a zero response in perfectly smooth areas and a high response in textured areas or areas including a sharp edge. Thus, given the presence of an edge in the portion 10 of the image data, a high response can be expected.

The filter coefficients 30 are applied to the portion 10 of the image data by the filter 2. The filter coefficients are applied using a conventional convolution operation. That is, each pixel value of the portion 10 of the image data is multiplied by the corresponding coefficient of the array 30. This generates a 3-by-3 matrix of output values 40.

That is, the top left hand pixel value of the portion 10 (128) is multiplied by the top left hand coefficient of the matrix 30 (−1) to generate a value (−128) for the top left hand element of the matrix 40. Other elements of the portion 10, and the matrix 30 are similarly processed. When nine values have been generated for the matrix 40 (as shown in FIG. 2) these values are summed to generate a common filtered value for the center pixel of the portion of image data 10.

The multiplications and subsequent sum (which correspond to the term (x*G₀)(n) of equation (1) and represent operation of the filter 2 of FIG. 1 for the portion 10) are as follows:

(128*−1)+(128*−1)+(128*−1)+(230*−1)+(230*8)+(230*−1)+(230*−1)+(230*1)+(230*−1)=306 (3)

That is, after filtering, the center pixel of the portion 10 will have a value of 306.

Referring back to FIG. 1, it can be seen that in the portion 10, the watermark w will then be given a relatively high weighting given the output value of the filtration process. This is not desirable given that the portion 10 includes a sharp edge and, as explained above, distortion caused by the watermark is likely to be perceptible in that region. The same result occurs if a vertical edge is present within the image.

In accordance with the described embodiment of the present invention, the filter coefficients of each row have a sum which is zero, and the filter coefficients of each column similarly have a sum which is zero. That is, where the filter is generically represented by equation (4):

$$C = [ \begin{matrix}{c}_{00} & {c}_{01} & {c}_{02} \\ {c}_{10} & {c}_{11} & {c}_{12} \\ {c}_{20} & {c}_{21} & {c}_{22}\end{matrix} ] \qquad ( 4 )$$

### Then:

c₀₀=−(c₀₁+c₀₂) (5)

c₁₀=c₀₁+c₀₂+c₂₁+c₂₂, (6)

c₁₁=−(c₀₁+c₂₁) (7)

c₁₂=−(c₀₂+c₂₂) (8)

c₂₀=−(c₂₁+c₂₂) (9)

where c₀₁, c₀₂, c₂₁ and c₂₂ are free parameters.

A special case of the filter of equation (4) occurs when the matrix is constructed using a one-dimensional filter having a mean zero. That is, when the two dimensional matrix of equation (4) is construed using a Kronecker tensor product, as shown in equation (10):

$${C}_{8} = [ \begin{matrix}{c}_{0} \\ {c}_{1} \\ {c}_{2}\end{matrix} ] [ \begin{matrix}{c}_{0} & {c}_{1} & {c}_{2}\end{matrix} ] = [ \begin{matrix}{c}_{0}^{2} & {c}_{0} {c}_{1} & {c}_{0} {c}_{2} \\ {c}_{1} {c}_{0} & {c}_{1}^{2} & {c}_{1} {c}_{2} \\ {c}_{2} {c}_{0} & {c}_{2} {c}_{1} & {c}_{2}^{2}\end{matrix} ] \qquad 10 )$$

It can be deduced that the columns and rows of C₈ add up to zero, given that:

c₀+c₁+c₂=0 11)

One example of a filter such as that of equation (10) is shown in equation (12):

$${G}_{0} = [ \begin{matrix}- 1 / 4 \\ 1 / 2 \\ - 1 / 4\end{matrix} ] [ \begin{matrix}- 1 / 4 & 1 / 2 & - 1 / 4\end{matrix} ] = [ \begin{matrix}\frac{1}{16} & - \frac{1}{8} & \frac{1}{16} \\ - \frac{1}{8} & \frac{1}{4} & - \frac{1}{8} \\ \frac{1}{16} & - \frac{1}{8} & \frac{1}{16}\end{matrix} ] = \frac{1}{16} [ \begin{matrix}1 & - 2 & 1 \\ - 2 & 4 & - 2 \\ 1 & - 2 & 1\end{matrix} ] \\ \qquad 12 )$$

FIG. 3 shows filtering of the portion 10 of the image data 1 using the filter of equation (12). In FIG. 3, the filter of equation (12) is represented by an array 31. The filter is applied to the portion 10 of the image data 1 by the filter 2 using a conventional convolution operation as described above. This generates an array 41 of output values, which are summed to produce the filtered values. It can be seen that the sum of each row and each column of the array 41 is zero. That is, using the filter of equation (12) the watermark will add no distortion to areas including sharp horizontal edges. Similar results are obtained when the filter of equation (12) is applied to areas including sharp vertical edges and smooth areas.

Although the filter of equation (12) ensures that distortion is not added to areas including horizontal and vertical edges, distortion is still added in areas including diagonal edges. Indeed, the filter of equation (12) is a low-pass filter with an attenuation of 20 log (6/16)≈−8.5 dB in the pass-band. Indeed, the filter of equation (12) is a Laplacian filter in which the horizontal and vertical component is zero. The filter of equation (12) can be written as:

$${G}_{0} = \frac{1}{16} ( {L}_{{d}_{1}} + {L}_{{d}_{2}} ) \qquad ( 13 )$$

where:

$${L}_{{d}_{1}} [ \begin{matrix}2 & - 1 & - 1 \\ - 1 & 2 & - 1 \\ - 1 & - 1 & 2\end{matrix} ]$$

$${L}_{{d}_{2}} [ \begin{matrix}- 1 & - 1 & 2 \\ - 1 & 2 & - 1 \\ 2 & - 1 & - 1\end{matrix} ]$$

By allowing that the rows and columns need not add up to exactly zero, a somewhat different filter can be created, so as to allow some watermark energy to be applied around horizontal and vertical edges. That is:

$$G = \frac{1}{16} ( {L}_{{d}_{1}} + {L}_{{d}_{2}} ) + {α}_{h} {L}_{h} + {α}_{v} {L}_{v} \qquad ( 14 )$$

where:

$${L}_{h} = [ \begin{matrix}- 1 & 2 & - 1 \\ - 1 & 2 & - 1 \\ - 1 & 2 & - 1\end{matrix} ]$$

$${L}_{v} = [ \begin{matrix}- 1 & - 1 & - 1 \\ 2 & 2 & 2 \\ - 1 & - 1 & - 1\end{matrix} ] ; and$$

αₕ and αᵥ are small scalar values

Alternatively, the filter can be created such that its coefficients add up to zero in the horizontal direction, the vertical direction, and across both diagonals. That is:

$${G}_{1} = [ \begin{matrix}{G}_{11} & - ( 2 {G}_{11} + {G}_{21} ) & {G}_{11} + {G}_{21} \\ {G}_{21} & 0 & - {G}_{21} \\ - ( {G}_{11} + {G}_{21} ) & 2 {G}_{11} + {G}_{21} & - {G}_{11}\end{matrix} ] \qquad ( 15 )$$

where G11 and G21 are free parameters.

For example, the filter of equation (15) could be as shown in equation (16):

$$G = \frac{1}{8} [ \begin{matrix}- 1 & 0 & 1 \\ 2 & 0 & - 2 \\ - 1 & 0 & 1\end{matrix} ] \qquad ( 16 )$$

In preferred embodiments of the present invention, the filter G₀ of equation (1) is defined by equation (12). This filter was selected on the basis of experiments which showed that such a filter provided good results. It will be appreciated that filtering using this filter can be implemented as efficiently as filtering using a conventional Laplacian filter of the type shown in equation (2). However, while using the Laplacian filter is likely to add distortion to areas in which distortions as relatively perceptible (i.e. around horizontal and vertical edges), using the filters of equations (13) and (16) will add distortion only in textured areas, given that the filter will provide an output of zero in areas including a sharp edge, and an output of zero in smooth areas.

The embodiment of the invention described above has explained how watermarks can be embedded within images. It will be appreciated that the techniques described above are equally applicable in the case of video data where watermarks are embedded within the images of a plurality of frames of the video data using the methods set out above. Furthermore, it will be appreciated that the invention can be used to embed data other than watermarks within two dimensional information signals and it will also be appreciated that the information signal can take forms other than image data.

Although particular rectangular 3×3 filters have been described above, it will be appreciated that filters of other sizes, including non rectangular filters, could be used. Additionally, although two dimensional filters have been described above it will be appreciated that the invention could be implemented using a plurality of one dimensional filters. For example, the image could be filtered using a pair of one dimensional filters, each configured to apply a net weighting of approximately zero to the image in one direction. These filters could be as follows:

$$[ \begin{matrix}- 1 & 2 & - 1\end{matrix} ] and [ \begin{matrix}- 1 \\ 2 \\ - 1\end{matrix} ]$$

In summary, the invention relates to a method of embedding data such as a watermark in a two dimensional information signal such as an image. The method comprises filtering a portion of the information signal using a two dimensional filter. In order to reduce the visibility of the watermark in sharp and elongated edges, the filter is configured to apply a net weighting of approximately zero to the portion of the information signal in at least two non parallel directions. Preferably, the two directions are mutually orthogonal, e.g. horizontal and vertical. The thus filtered signal is used to locally control the watermark embedding depth (energy).

Although preferred embodiments of the present invention have been described above it will be appreciated that various modifications can be made to the invention without departing from the scope of the appended claims.

1. A method of embedding data in a two-dimensional information signal, the method comprising:
filtering a portion of said information signal, said filtering applying a net weighting of approximately zero to said portion of said information signal in at least two non-parallel directions, to generate filtered data; and
embedding said data in said information signal based upon said filtered data.

2. A method according to claim 1, wherein said filtering is carried out using a two dimensional filter configured to apply a net weighting of approximately zero to said portion of said information signal in at least two non-parallel directions.

3. A method according to claim 1, wherein said filtering is carried out using a pair of filters, a first filter being configured to apply a net weighting of approximately zero to said portion of said information signal in a first direction, and a second filter being configured to apply a net weighting of approximately zero to said portion of said information signal in a second direction, said first and second directions being non-parallel.

4. A method according to claim 1, wherein said data is a watermark.

5. A method according to 1, wherein said filtering is configured to apply a net weighting of approximately zero to said portion of said information signal in two mutually orthogonal directions.

6. A method according to claim 1, wherein said filtering is configured to apply a net weighting of approximately zero to said portion of said information signal in two pairs of mutually orthogonal directions.

7. A method according to claim 1, wherein said filtering is defined by coefficients arranged in a predetermined plurality of rows and a predetermined plurality of columns, the coefficients of each row having a sum which is substantially equal to zero and the coefficients of each column having a sum which is substantially equal to zero.

8. A method according to claim 7, wherein said rows and columns form a matrix, and coefficients of at least one principal diagonal of said matrix have a sum which is substantially equal to zero.

9. A method according to claim 1, wherein said two-dimensional filter is generated using a Kronecker tensor product.

10. A method according to claim 1, wherein said information signal is an image.

11. A carrier medium carrying computer readable instructions, the instructions being configured to cause a computer to carry out a method according to claim 1.

12. A computer apparatus for embedding a watermark in an information signal, the apparatus comprising:
a program memory storing processor readable instructions; and
a processor configured to read and execute instructions stored in said program memory;
wherein the processor readable instructions comprise instructions controlling the processor to carry out the method of claim 1.

13. Apparatus for embedding a data in a two-dimensional information signal, the apparatus comprising:
filtering means for filtering a portion of said information signal, said filtering means applying a net weighting of approximately zero to said portion of said information signal in at least two non-parallel directions, to generate filtered data; and
embedding means for embedding said data in said information signal based upon said filtered data.
